(19) United States
(12) Patent Application Publication
(10) Pub. No.: US 2008/0101672 A1
(43) Pub. Date: May 1, 2008

(54) IMAGE PROCESSING METHOD

(75) Inventor: Kazuhiko Matsumoto, Tokyo (JP)

Correspondence Address: PEARNE & GORDON LLP, 1801 EAST 9TH STREET, SUITE 1200, CLEVELAND, OH, 44114-3108, US

(73) Assignee: ZIOSOFT INC., Tokyo (JP)

(21) Appl. No.: 11/923,053

(22) Filed: Oct. 24, 2007

(30) Foreign Application Priority Data
Oct. 27, 2006 (JP) 2006-292674

(51) Int. Cl. G06K 9/00

(52) U.S. Cl. 382/128; 382/190

(57) ABSTRACT

The present invention provides an image processing method capable of acquiring any image analysis processing result desired by the user in a short time. First, volume data is analyzed and a finite number of input candidates are created (step S11) and image analysis processing is performed using the input candidates (step S12). Next, the user is requested to select an input candidate (step S13) and the analysis result corresponding to the selected input candidate is displayed (step S14). Thus, according to an image processing method of the invention, user input is predicted, a finite number of input candidates are created, and image analysis is conducted using the input candidates, so that when the user selects an input candidate, immediately the analysis result corresponding to the selected input candidate can be displayed.

This application is based on and claims priority from Japanese Patent Application No. 2006-292674, filed on Oct. 27, 2006, the entire contents of which are hereby incorporated by reference.

### BACKGROUND OF THE INVENTION

1. Technical Field

This invention relates to an image processing method for performing image analysis processing on volume data based on a parameter.

2. Background Art

Hitherto, image analysis has been conducted for directly observing the internal structure of a human body according to the tomographic image of a living body photographed with a Computed Tomography (CT) apparatus, a Magnetic Resonance Imaging (MRI) apparatus, or the like. Further, volume rendering has been conducted in recent years. The volume rendering represents a three-dimensional space by voxels (volume elements) separated small like a lattice based on digital data (volume data) generated by stacking tomographic images by a CT apparatus, an MRI apparatus, or the like. Then, the volume rendering the densities of the voxel data and renders a distribution of the concentration and the density of an object as a translucent three-dimensional image. Thus, the volume rendering makes it possible to visualize the inside of a human body hard to understand simply from the tomographic image of the human body.

Known as the volume rendering is ray casting for applying virtual ray to an object from a virtual eye point, forming an image based on virtual reflected light from the object inside on a virtual projection plane, and viewing through a three-dimensional structure of the object inside or the like. To conduct medical diagnosis using an image generated by the ray casting, voxels need to be made small for enhancing the precision of the image because the internal structure of a human body is extremely complicated. However, the more enhanced the precision, the more enormous the data amount; it takes time in calculation processing to create image data.

On the other hand, in the actual image diagnosis, an operation sequence of displaying the part to be diagnosed on a monitor screen, repeating the same operation of moving the display angle little by little and moving the display position little by little to observe the affected part, compiling diagnosis information into a report of the diagnosis result, etc., and terminating the processing is repeated.

In the image diagnosis, the human body to be diagnosed varies from one diagnosis to another and an image is not previously provided and therefore operator's operation is input and then the image data of a volume rendering image must be created by calculation in accordance with the input operation. That is, in a system of a related art, when medical image data arrives at a medical image processing server, given image processing may be performed, but processing requiring user's input is performed after user's input arrives at the medical image processing server. For example, in the medical image processing server, given processing of filtering, etc., is performed when medical image data arrives at the medical image processing server, but processing that can be previously performed without waiting for user's input is only processing whose result is determined uniquely. Thus, extraction of an organ to be diagnosed and a search for a vessel are performed after the user calls an image.

FIGS. 18 and 19 are drawings to describe the schematic configuration and processing steps of a processing system of medical image data. The image processing system in a related art is made up of a data sever 11 for storing volume data acquired by a CT apparatus, etc., an image processing server 12 for performing image processing of region extraction, etc., and a client 13 for displaying the image processing result.

To perform predetermined image processing, the medical image data stored in the data server 11 is transferred to the image processing server 12 (step 1). Next, if the user inputs the region of interest to be observed in detail, for example, in the client 13, the user input is sent to the image processing server 12 (step 2).

Upon reception of the user input, the image processing server 12 conducts an image analysis on the medical image data in accordance with the user input (step 3 in FIG. 19). Next, the image processing server 12 transfers the image analysis result complying with the user input to the client 13. Accordingly, the client 13 can display the image analysis result complying with the user input (step 4).

A related art of creating a plurality of preview images and setting a Look-Up Table (LUT) exists in relation to such an image processing method. (For example, refer to U.S. Pat. No. 5,986,662.)

However, in the image processing method in the related art described above, the time from user's input required for image analysis to acquisition of the analysis result is long and thus the load on the user is large and the algorithm taking much time is not realistic and cannot be used. Trial and error becomes necessary several times until acquisition of the analysis result desired by the user and the time is taken and thus image diagnosis cannot smoothly be conducted. In the invention disclosed in U.S. Pat. No. 5,986,662, different types of initialization are only provided and examples are only presented to the user.

It is therefore an object of the invention to provide an image processing method capable of acquiring any image analysis processing result desired by the user in a short time.

### SUMMARY OF THE INVENTION

According to the invention, there is provided an image processing method for performing image analysis processing on volume data based on a parameter, the image processing method comprising:

creating a plurality of parameter candidates by analyzing the volume data;

performing the image analysis processing on the volume data based on each of the plurality of parameter candidates; and

selecting at least one parameter from among the plurality of parameter candidates.

In the image processing method of the invention, the plurality of parameter candidates may be provided by filtering mutually similar results of the image analysis processing results based on the parameter candidates.

In the image processing method of the invention, the image analysis processing may be performed in a server and the parameter is selected through a user interface of a client.

It is preferable that the image processing method of the invention further comprises:

specifying any other parameter than the plurality of parameter candidates.

It is preferable that the image processing method of the invention further comprises:

performing additional image analysis processing on the image analysis processing result based on the selected parameter.

In the image processing method of the invention, the image analysis processing may be region extraction processing.

In the image processing method of the invention, said step of creating a plurality of parameter candidates by analyzing volume data may be triggered by the volume data arrival to a data server.

According to the invention, there is provided an image processing method for performing image analysis processing on volume data based on a parameter, said image processing method comprising:

creating a plurality of parameter candidates by analyzing the volume data;

performing the image analysis processing on the volume data based on each of the plurality of parameter candidates; and

selecting at least one result from among a plurality of image analysis processing results based on the plurality of parameter candidates.

In the image processing method of the invention, the plurality of parameter candidates maybe provided by filtering mutually similar results of the image analysis processing results based on the parameter candidates.

In the image processing method of the invention, the image analysis processing may be performed in a server and the image analysis processing result is selected through a user interface of a client.

It is preferable that the image processing method of the invention further comprises:

specifying any other parameter than the plurality of parameter candidates.

It is preferable that the image processing method of the invention further comprises:

performing additional image analysis processing on the image analysis processing result based on the selected image analysis processing result.

It is preferable that the image processing method of the invention further comprises:

displaying the plurality of image analysis processing results.

In the image processing method of the invention, the image analysis processing may be region extraction processing.

In the image processing method of the invention, said step of creating a plurality of parameter candidates by analyzing volume data may be triggered by the volume data arrival to a data server.

According to the invention, there is provided an image-analysis apparatus performing an image analysis processing on volume data based on a parameter, said image analysis processing comprising:

creating a plurality of parameter candidates by analyzing the volume data;

performing the image analysis processing on the volume data based on each of the plurality of parameter candidates; and

selecting at least one parameter from among the plurality of parameter candidates.

In the image-analysis apparatus of the invention, the plurality of parameter candidates may be provided by filtering mutually similar results of the image analysis processing results based on the parameter candidates.

In the image-analysis apparatus of the invention, the image analysis processing may be performed in a server and the parameter is selected through a user interface of a client.

It is preferable that said image analysis processing further comprises:

performing additional image analysis processing on the image analysis processing result based on the selected parameter.

According to the invention, there is provided an image-analysis apparatus performing an image analysis processing on volume data based on a parameter, said image analysis processing comprising:

creating a plurality of parameter candidates by analyzing the volume data;

performing the image analysis processing on the volume data based on each of the plurality of parameter candidates; and

selecting at least one result from among a plurality of image analysis processing results based on the plurality of parameter candidates.

In the image-analysis apparatus of the invention, the plurality of parameter candidates may be provided by filtering mutually similar results of the image analysis processing results based on the parameter candidates.

In the image-analysis apparatus of the invention, the image analysis processing may be performed in a server and the image analysis processing result is selected through a user interface of a client.

It is preferable that said image analysis processing further comprises:

performing additional image analysis processing on the image analysis processing result based on the selected image analysis processing result.

It is preferable that said image analysis processing further comprises:

displaying the plurality of image analysis processing results.

According to the invention, previously the volume data is analyzed, a plurality of parameter candidates are created, and the image analysis processing is performed on the volume data based on the plurality of parameter candidates, whereby if any of the parameters and the user-desired parameter match, the user can acquire the desired image analysis result in a short time.

### BRIEF DESCRIPTION OF THE DRAWINGS

In the accompanying drawings:

FIG. 1 is a drawing to schematically show a computed tomography (CT) apparatus used with an image processing method of an embodiment of the invention;

FIG. 2 is a flowchart to describe an outline of the image processing method of the embodiment of the invention;

FIG. 3 is a drawing (1) to describe the processing steps for requesting the user to select an input candidate in an image processing method according to example 1 of the invention;

FIG. 4 is a drawing (2) to describe the processing steps for requesting the user to select an input candidate in the image processing method according to example 1 of the invention;

FIG. 5 is a drawing (3) to describe the processing steps for requesting the user to select an input candidate in the image processing method according to example 1 of the invention;

FIG. 6 is a drawing (4) to describe the processing steps for requesting the user to select an input candidate in the image processing method according to example 1 of the invention;

FIG. 7 is a drawing (5) to describe the processing steps for requesting the user to select an input candidate in the image processing method according to example 1 of the invention;

FIG. 8 is a drawing (1) to describe the processing steps for requesting the user to select an image analysis result in an image processing method according to example 2 of the invention;

FIG. 9 is a drawing (2) to describe the processing steps for requesting the user to select an image analysis result in the image processing method according to example 2 of the invention;

FIG. 10 is a drawing (3) to describe the processing steps for requesting the user to select an image analysis result in the image processing method according to example 2 of the invention;

FIG. 11 is a drawing (4) to describe the processing steps for requesting the user to select an image analysis result in the image processing method according to example 2 of the invention;

FIG. 12 is a drawing (1) to show an example of user input candidates in the embodiment of the invention;

FIG. 13 is a drawing (2) to show an example of user input candidates in the embodiment of the invention;

FIG. 14 is a drawing (3) to show an example of user input candidates in the embodiment of the invention;

FIG. 15 is a flowchart (1) of a user input candidate creation method in the image processing method of the embodiment of the invention;

FIG. 16 is a flowchart (2) of the user input candidate creation method in the image processing method of the embodiment of the invention;

FIG. 17 is a schematic representation to show an example of additional image analysis processing in the image processing method of the embodiment of the invention;

FIG. 18 is a drawing (1) to describe the schematic configuration and processing steps of a medical image data processing system in a related art; and

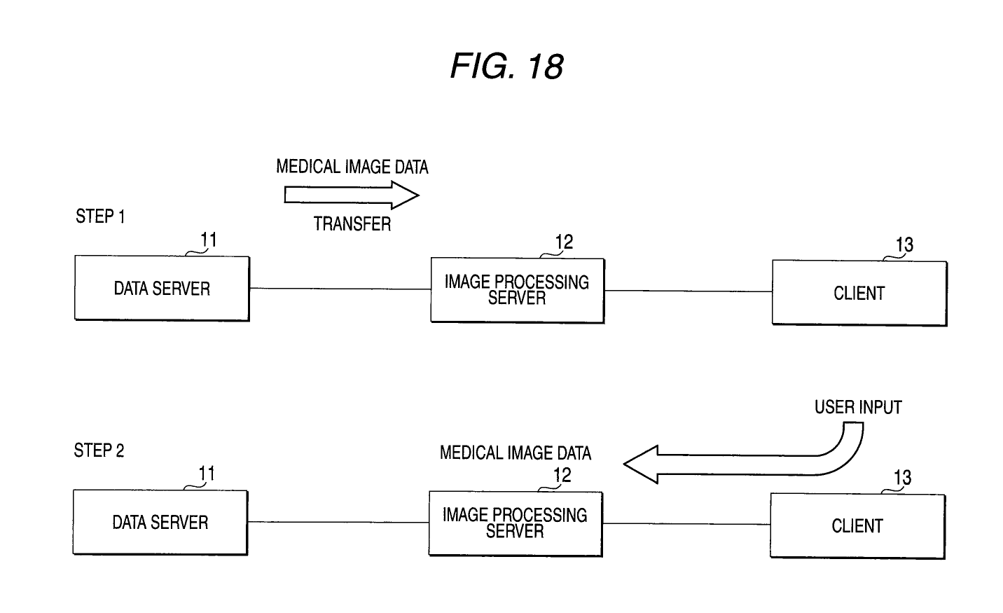

FIG. 19 is a drawing (2) to describe the schematic configuration and processing steps of the medical image data processing system in the related art.

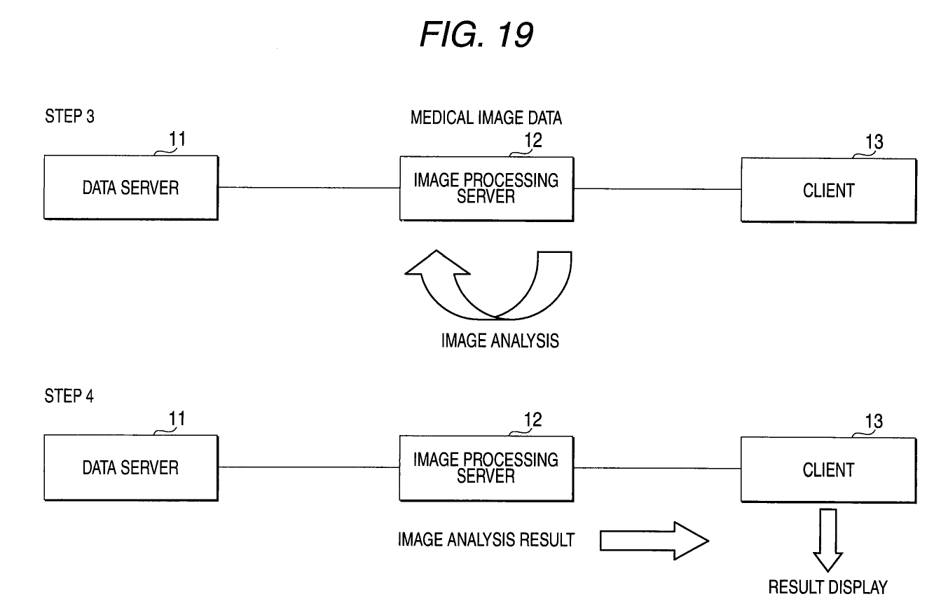

### DETAILED DESCRIPTION OF EXEMPLARY EMBODIMENTS

An embodiment of an image processing method of the invention will be discussed. The image processing method according to the invention is intended mainly for handling a medical image rendered using volume data or the like, and image processing is implemented as a computer program.

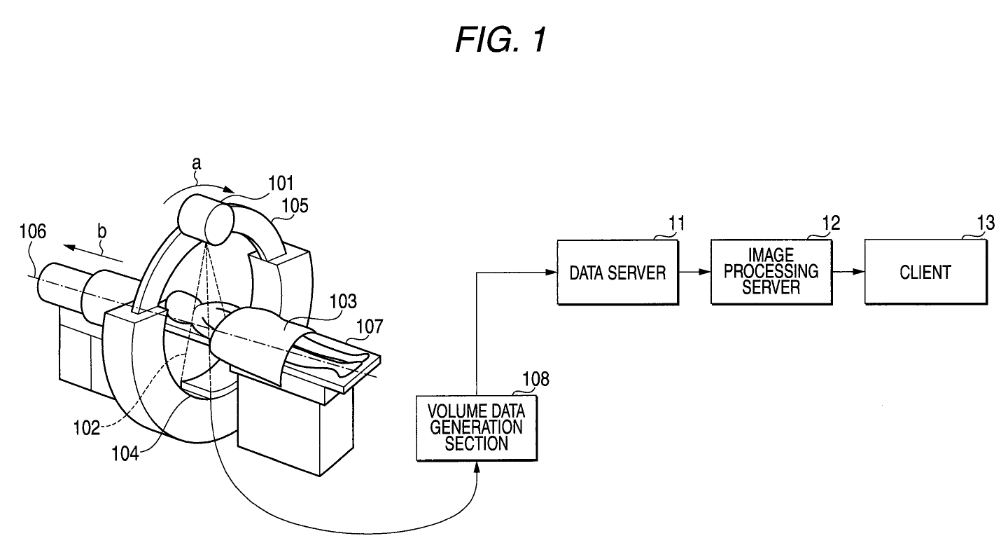

FIG. 1 schematically shows a computed tomography (CT) apparatus used with an image processing method according to one embodiment of the invention. The computed tomography apparatus visualizes the tissue, etc., of a specimen. The CT apparatus shown in FIG. 1 is connected to a data server 11, an image processing server 12, and a client 13 through a network. An X-ray beam bundle 102 shaped like a pyramid having a marginal part beam indicated by the chain line in the figure is radiated from an X-ray source 101. The X-ray beam bundle 102 passes through a specimen of a patient 103, for example, and is applied to an X-ray detector 104. The X-ray source 101 and the X-ray detector 104 are placed facing each other on a ring-like gantry 105 in the embodiment. The ring-like gantry 105 is supported on a retainer (not shown in the figure) for rotation (see arrow a) relative to a system axis 106 passing through the center point of the gantry.

The patient 103 lies down on a table 107 through which an X ray passes in the embodiment. The table is supported by a retainer (not shown) so that it can move along the system axis 106 (see arrow b)

Therefore, the X-ray source 101 and the X-ray detector 104 make up a measurement system that can rotate with respect to the system axis 106 and can move relatively to the patient 103 along the system axis 106, so that the patient 103 can be projected at various projection angles and at various positions relative to the system axis 106. An output signal of the X-ray detector 104 generated at the time is supplied to a volume data generation section 111, which then converts the signal into volume data.

In a sequence scan, scanning is executed for each layer of the patient 103. At the time, the X-ray source 101 and the X-ray detector 104 rotate around the patient 103 with the system axis 106 as the center, and the measurement system including the X-ray source 101 and the X-ray detector 104 photographs a large number of projections to scan two-dimensional tomograms of the patient 103. A tomographic image to display the scanned tomogram is again composed from the measurement values acquired at the time. The patient 103 is moved along the system axis 106 each time in scanning successive tomograms. This process is repeated until all tomograms of interest are captured.

On the other hand, during spiral scanning, the measurement system including the X-ray source 101 and the X-ray detector 104 rotates on the system axis 106 and the table 107 moves continuously in the direction of the arrow b. That is, the measurement system including the X-ray source 101 and the X-ray detector 104 moves continuously on the spiral orbit relatively to the patient 103 until all regions of interest of the patient 103 are captured. In the embodiment, the computed tomography apparatus shown in the figure supplies a large number of successive tomographic signals in the diagnosis range of the patient 103 to the volume data generation section 111. The volume data generation section 111 generates volume data from the supplied tomographic signals.

The volume data generated by the volume data generation section 111 is supplied to the data server 11. The medical image data stored in the data server 11 is transferred to the image processing server 12 and image processing responsive to the request received from the client 13.

When the medical image data arrives at the image processing server 12, the image processing server 12 performs given image processing. The client 13 includes an operation section and a display. The operation section contains a graphical user interface (GUI) for setting parameters for operation in response to an operation signal from a keyboard, a mouse, etc., and supplies a control signal responsive to the setup value to the image processing server 12. The display displays the result of the image analysis processing performed by the image processing server 12 and the like. While seeing the image, etc., displayed on the display of the client 13, the user can conduct an image diagnosis. In the image processing method in the related art, processing requiring user input, such as region extraction is started when user input arrives and thus the user must wait for a long time until any desired image analysis result is produced, as described above. In the image processing method of the embodiment, the image processing server 12 previously conducts an image analysis for the processing requiring user input, whereby the user can acquire any desired image analysis result in a short time in the client 13.

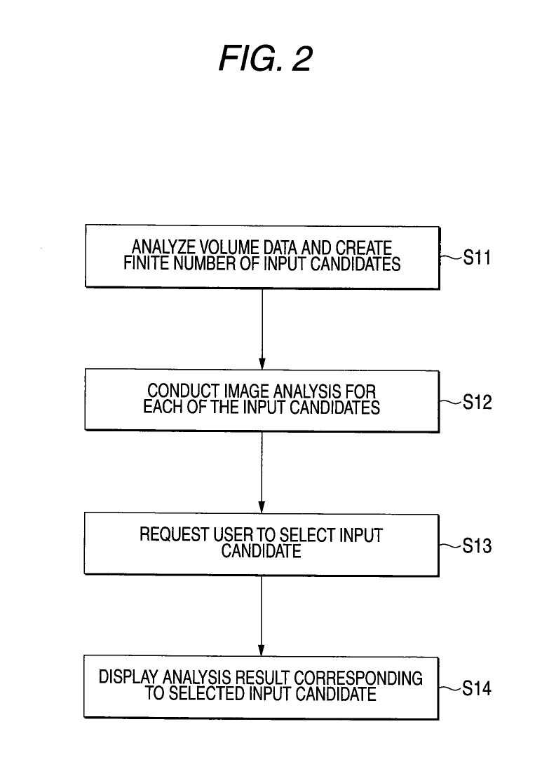

FIG. 2 is a flowchart to describe an outline of the image processing method according to the embodiment of the invention. In the image processing method of the embodiment, first, volume data is analyzed, a parameter is predicted, and a finite number of input candidates (parameter candidates) are created (step S11) and image analysis is conducted for each of the input candidates (step S12). Next, the user is requested to select an input candidate (step S13) and the analysis result corresponding to the selected input candidate is displayed (step S14).

Thus, according to the image processing method of the embodiment, user input is predicted, a finite number of input candidates are created, and image analysis is conducted for each of the input candidates, so that when the user selects an input candidate, immediately the analysis result corresponding to the selected input candidate can be displayed. It is desirable that the processing shown in FIG. 2 should be started provided that volume data arrives at the data server.

### EXAMPLE 1

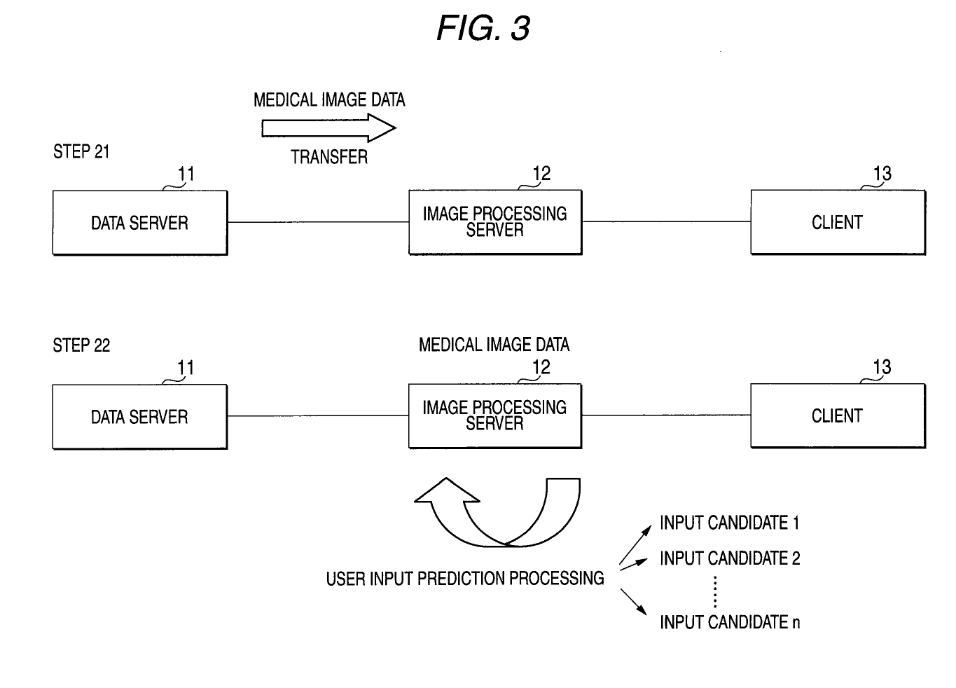

FIGS. 3 to 7 are drawings to describe the processing steps for requesting the user to select an input candidate in an image processing method according to example 1 of the embodiment. In the image processing method of the example, first, medical image data stored in the data server 11 is transferred to the image processing server 12 (step S21). Next, the image processing server 12 performs user input prediction processing and creates input candidate 1, input candidate 2, . . . , input candidate n (a plurality of parameter candidates) (step 22).

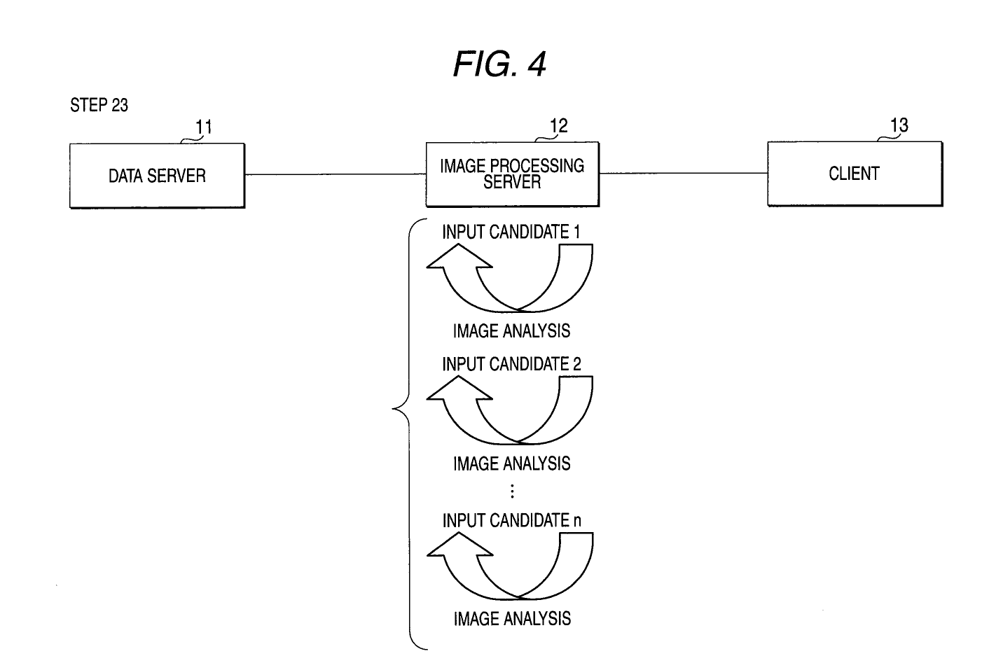

Next, the image processing server 12 performs image analysis processing corresponding to the created input candidate 1, input candidate 2, . . . , input candidate n and generates image analysis result 1, image analysis result 2, image analysis result n (step 23 in FIG. 4).

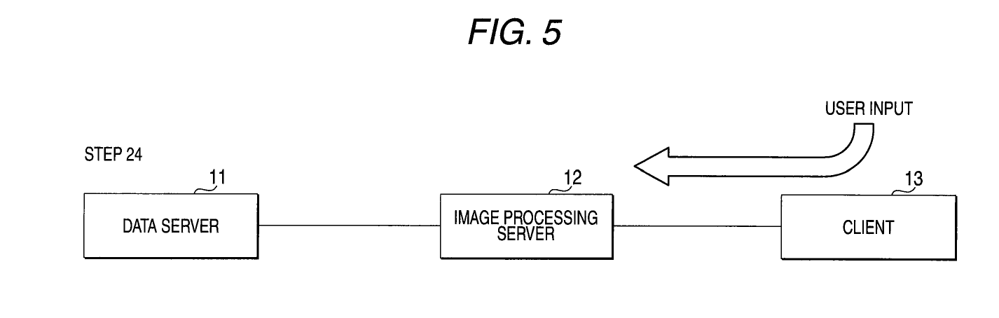

Next, the user inputs a parameter indicating the region of interest to be observed in detail or the like in the client 13, and the user input is transferred to the image processing server 12 (step 25 in FIG. 5). In this case, if the image processing server 12 causes the client to display the input candidate 1, input candidate 2, . . . , input candidate n, the user can select any input candidate from among them.

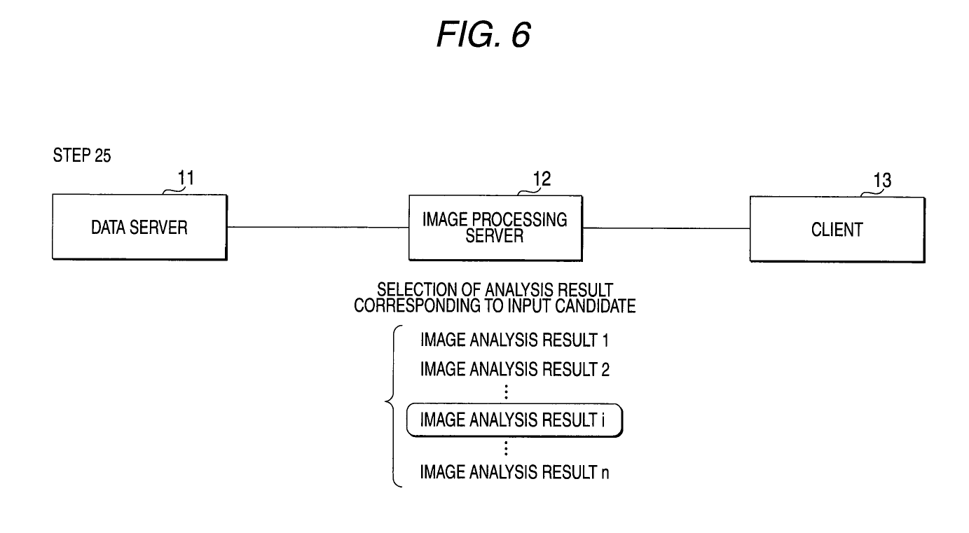

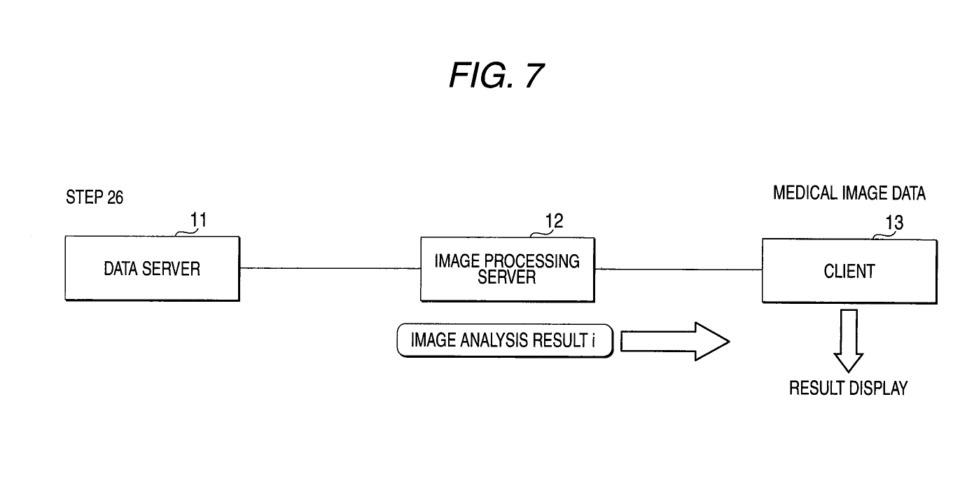

Next, upon reception of the user input, the image processing server 12 selects image analysis result i corresponding to the input candidate (step 25 in FIG. 6). It sends the selected image analysis result i to the client 13 for displaying the image analysis result i (step 26 in FIG. 7).

Thus, according to the image processing method of the example, the image processing server 12 performs the user input prediction processing, creates input candidate 1, input candidate 2, . . . , input candidate n, conducts image analysis corresponding to the created input candidate 1, input candidate 2, . . . , input candidate n, and generates image analysis result 1, image analysis result 2, . . . , image analysis result n, so that when the user selects or inputs any desired parameter, immediately the image analysis result i corresponding to the parameter can be displayed and image diagnosis can be conducted smoothly.

The following mode is also possible: After the user inputs a parameter, the image processing server 12 searches for an input candidate matching the user input in the image processing server 12 without displaying any input candidates.

The user can also input the value of any parameter other than the input candidates created by analyzing the volume data. That is, the image processing server 12 predicts a plurality of parameters and creates a plurality of input candidates, but does not present the prediction description (input candidates) to the user and allows the user to input a parameter as desired. The image processing server 12 makes a comparison between the user-input parameter and each of the input candidates and if the user-input parameter match any of the input candidates, the image processing server 12 presents the image analysis result corresponding to the input candidate to the user. On the other hand, if the user-input parameter does not match any of the input candidates, the image processing server 12 conducts an image analysis using the input parameter. In so doing, the user can be prevented from receiving a psychological effect from the presented input candidates. Particularly, the user can be prevented from compromising with the input candidates to conduct a diagnosis, so that the mode is effective in the medical diagnosis.

When the input candidates are presented to the user, if the user is not satisfied with any of the input candidates, the user may be allowed to input a parameter. It may be better to do so depending on the nature of the image analysis processing.

The following mode is also possible: If the user inputs any parameter other than the input candidates, it is learnt and later the parameter is adopted as an input candidate. The mode can improve the parameter prediction accuracy.

### EXAMPLE 2

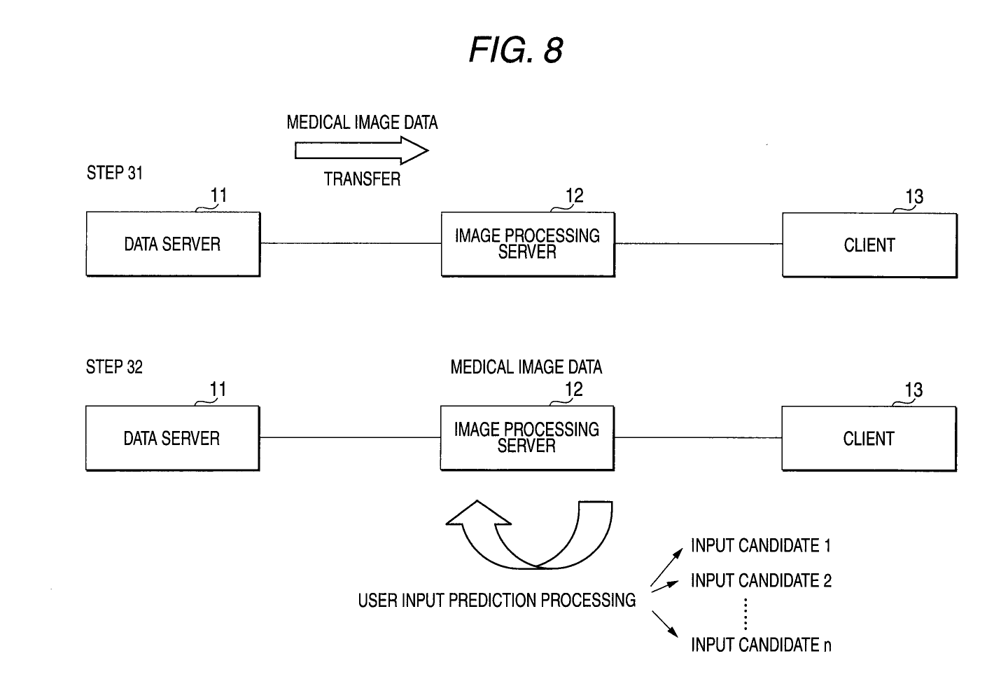

FIGS. 8 to 11 are drawings to describe the processing steps for requesting the user to select an image analysis result in an image processing method according to example 2 of the embodiment. In example 2, unlike example 1 wherein the user is requested to select a predicted input candidate, the user is requested to select the result of image analysis processing on each predicted input candidate. In the image processing method of the example, first, medical image data stored in the data server 11 is transferred to the image processing server 12 (step S31). Next, the image processing server 12 performs user input prediction processing and creates input candidate 1, input candidate 2, . . . , input candidate n (a plurality of parameter candidates) (step 32).

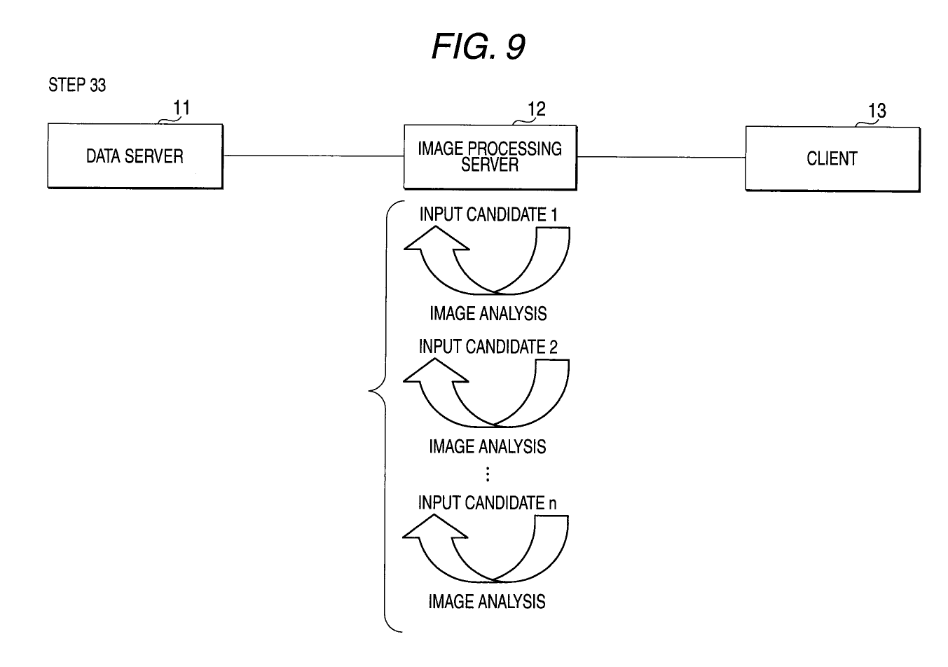

Next, the image processing server 12 performs image analysis processing corresponding to the created input candidate 1, input candidate 2, . . . , input candidate n and generates image analysis result 1, image analysis result 2, . . . , image analysis result n (step 33 in FIG. 9).

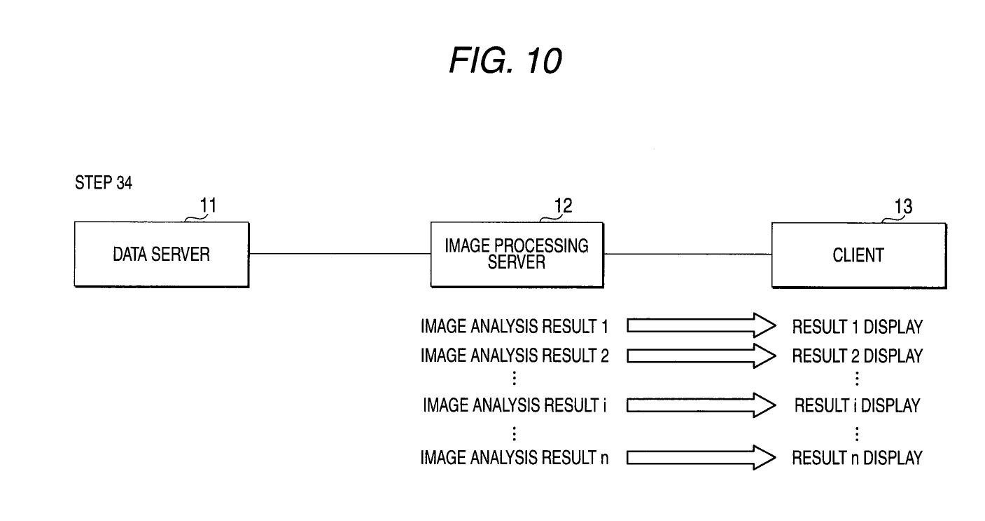

Next, the image processing server 12 sends the image analysis results corresponding to the input candidate 1, input candidate 2, . . . , input candidate i, . . . , input candidate n to the client 13, which then displays the image analysis result 1, image analysis result 2, . . . , image analysis result i, . . . , image analysis result n (step 34 in FIG. 10). In this case, the image analysis results displayed on the client 13 are detailed images, but preview images with the reduced data amount may be displayed.

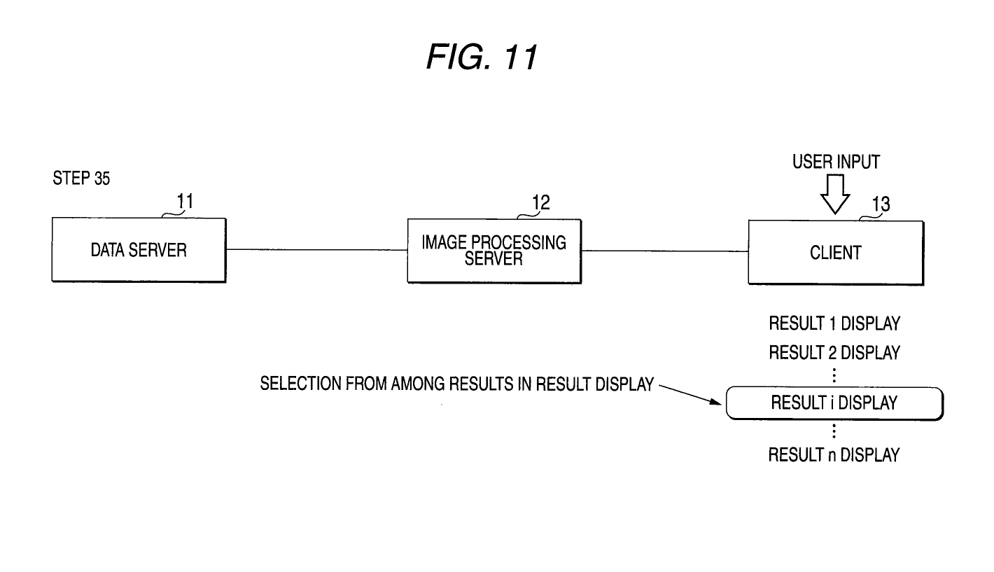

Next, in the client 13, the user selects image analysis result ii from among the image analysis result 1, image analysis result 2, . . . , image analysis result i, . . . , image analysis result n (step 35 in FIG. 11).

Thus, according to the image processing method of the example, the image processing server 12 performs the user input prediction processing, creates input candidate 1, input candidate 2, . . . , input candidate n, conducts image analysis corresponding to the created input candidate 1, input candidate 2, . . . , input candidate n, and generates image analysis result 1, image analysis result 2, . . . , image analysis result n. The image analysis result 1, image analysis result 2, . . . , image analysis result n are displayed on the client 13, so that the user can select desired image analysis result i and can immediately display the image analysis result i.

According to the example, complicated input parameters can be hidden from the user, so that the need for the user to think what input candidates are is eliminated and the user can select any desired image by intuition. This is effective for the case where the number of the input candidates is enormous, and can also prevent the user from being psychologically induced to any input candidate, resulting in careless operation.

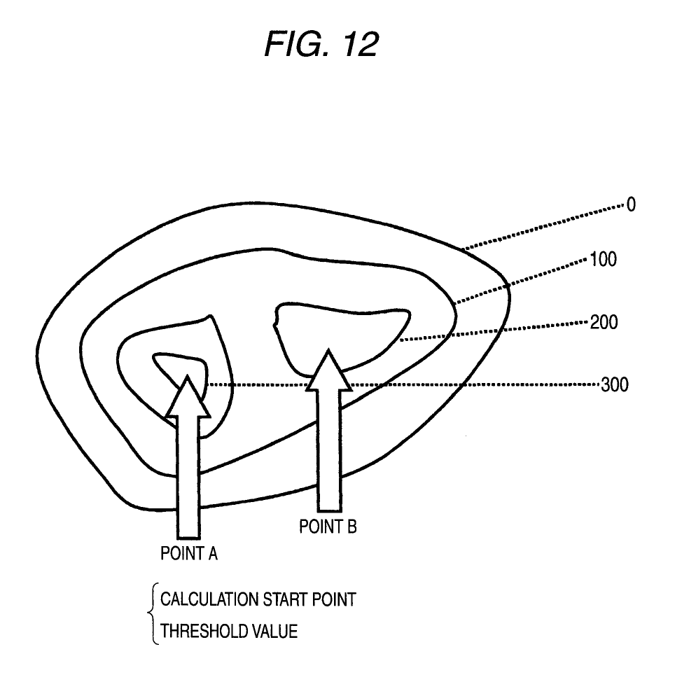

FIGS. 12 to 14 show examples of user input candidates (input parameter candidates) in the embodiment. To extract a partial region by segmentation according to a threshold value (namely, when the image analysis processing is region extraction processing using a region expansion method), the extraction condition becomes an input candidate. If volume data is acquired from a CT apparatus, the voxel value (CT value) is in the range of −100 to 1000 and thus the inspection target is extracted with the threshold value specified as a parameter in response to the inspection target. In FIG. 12, the value of a contour line indicates the threshold value of the voxel value. To specify a separated inspection target, for example, the maximum point of the voxel value, etc., is displayed as calculation start point A, B in the region expansion method.

In example 1, the user selects any input candidate from among “start point A, threshold value 200” (input candidate 1), “start point B, threshold value 200” (input candidate 2), and “start point A, threshold value 100” (input candidate 3) at step 24 in FIG. 5. In this case, to facilitate user selection, a drawing indicating the positions of start points A and B as in FIG. 12 is displayed.

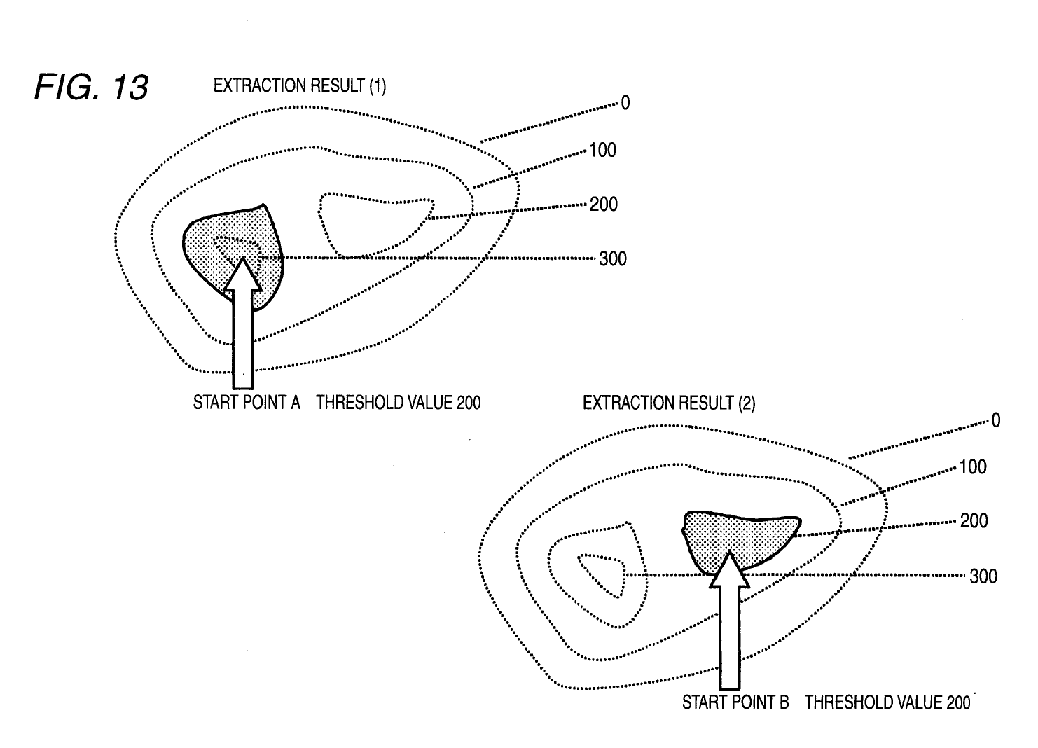

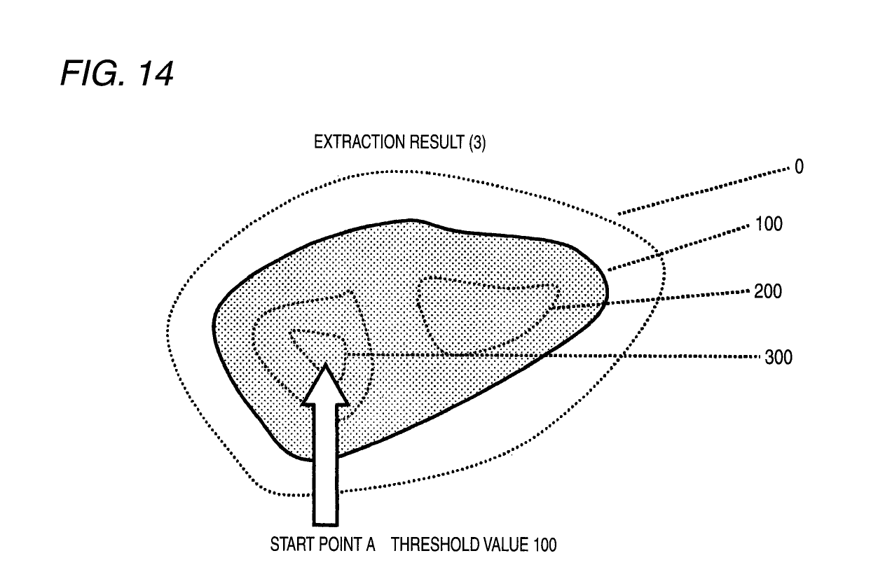

On the other hand, in example 2, the user selects any desired image (image analysis processing result) from among “image with start point A, threshold value 200” (extraction result (1)) and “image with start point B, threshold value 200” (extraction result (2)) shown in FIG. 13 and “image with start point A, threshold value 100” (extraction result (3)) shown in FIG. 14 at step 35 in FIG. 11.

Extraction result (1) is an extracted image of the region containing the start point A and surrounded by the threshold value 200, extraction result (2) is an extracted image of the region containing the start point B and surrounded by the threshold value 200, and extraction result (3) is an extracted image of the region containing the start point A and surrounded by the threshold value 100. Thus, representatives are predicted from among an infinite number of assumed parameters and input candidates are created.

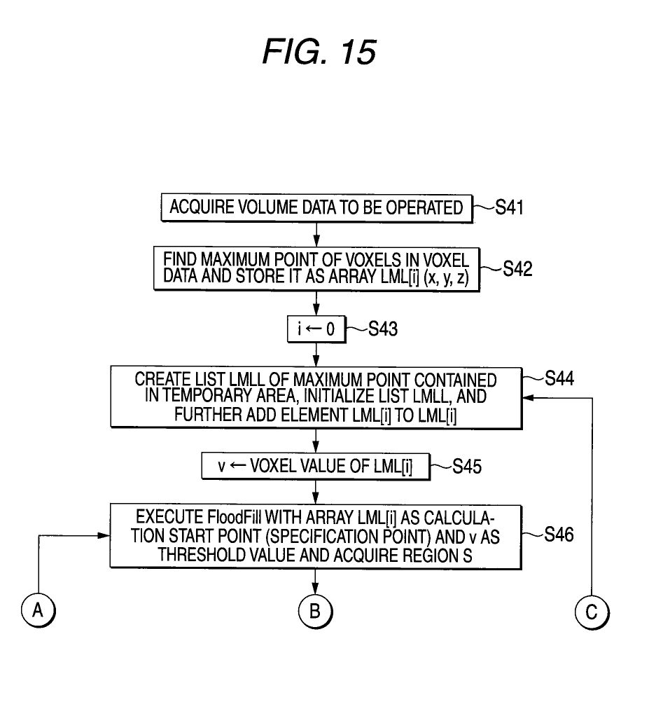

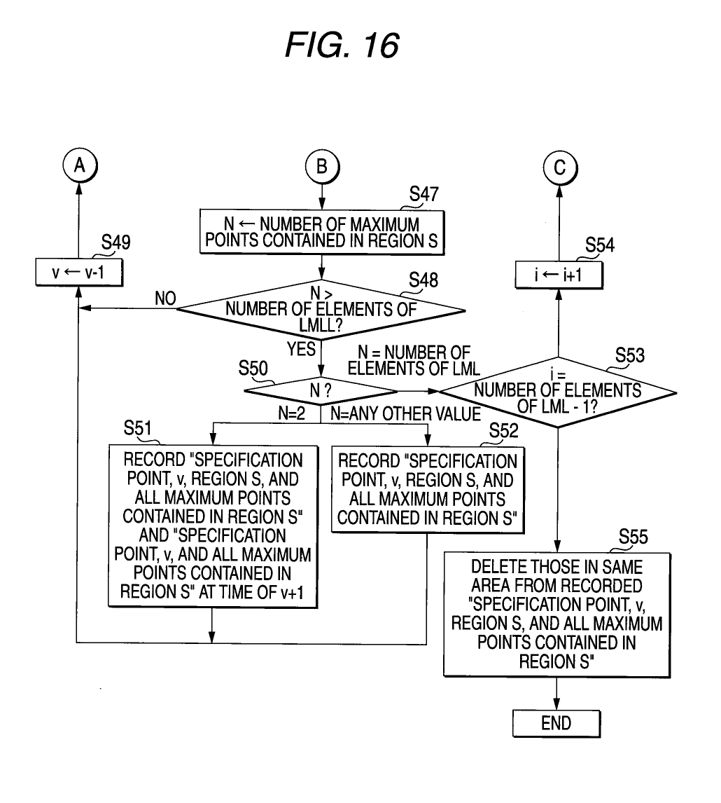

FIGS. 15 and 16 are flowcharts of a user input candidate creation method in the image processing method of the embodiment. To create an input candidate, first the volume data to be operated is acquired (step S41). The maximum point of voxels in the voxel data is found and is stored as an array LML[i] (x, y, z) . (x, y, z) represents the coordinates of the maximum point and the maximum point is identified according to the subscript i (step S42).

Next, an initial value 0 is assigned to a variable i (step S43), a list LMLL for storing the maximum point contained in a temporary area (region S created at step S46 described later) and is initialized as a null list, and further element LML[i] is added to the list LMLL (step S44). The voxel value of the array LML[i] is assigned to a variable v (step S45).

Next, FloodFill is executed with the array LML [i] as the calculation start point (specification point) and the variable v as the threshold value, and region S is acquired (step S46). The number of the maximum points contained in the region S is assigned to a variable N (step S47) and a comparison is made between the variable N and the number of elements of the array LML, thereby determining whether or not a new maximum point is added to the list LMLL (step S48). If the variable N is not greater than the number of elements of the array LML (NO), a new maximum point does not exist and only a similar result is obtained (namely, the results of image analysis processing based on the parameter candidates are similar to each other) and therefore no record is made for the region S and the region S is eliminated. The variable v is replaced with variable v-1 and the process returns to step S46 (step S49). As steps S46 to S49 are executed, the maximum voxel value in the region that can be created in FloodFill containing all elements contained in the list LMLL is found.

On the other hand, if the variable N is greater than the number of elements of the array LML (YES), the value of the variable N is determined (step S50). If the variable N is “2,” “specification point, variable v, region S, and all maximum points contained in region S” and “specification point, variable v, and all maximum points contained in region S” at the time of variable v=v+1 are recorded and the new maximum point added to the region S is added to the list LMLL (step S51) and the process goes to step S49. The purpose of performing special processing when the variable N is “2” is to specially record the region containing only one maximum point.

If the variable N is any other value, “specification point, variable v, region S, and all maximum points contained in region S” are recorded and the new maximum point added to the regions is added to the list LMLL (step S52) and the process goes to step S49. On the other hand, if the variable N is equal to the number of elements of the array LML at step S50, whether or not the variable i is equal to (number of elements of array LML−1) is determined (step S53) and if the variable i is not equal to (number of elements of array LML−1) (NO), i+1 is assigned to the variable i (step S54) and the process returns to step S44. As the loop is executed, whether or not a region that can be created by executing FloodFill exists is checked for all combinations of the maximum points.

On the other hand, if the variable i is equal to (number of elements of array LML−1) (YES), those in the same region are deleted from the recorded “specification point, variable v, region S, and all maximum points contained in region S” (step S55) and the processing is terminated. Accordingly, duplication occurring due to the element order difference in the list LMLL is deleted. An image with a poor S/N ratio or the like may contain a large number of maximum points. In such a case, the image may be subjected to smoothing processing so that an unnecessary maximum point can be removed and thus it is effective.

Next, the advantages and variations of the examples of user input candidate creation concerning regions will be discussed. The user can select a specification point consequently contained in a region and a combination of the specification points. If volume data is acquired from a CT apparatus, the voxel value is a CT value and bone=1000, muscle=50, water=0, and fat=−100 and thus the threshold value range may be 0 to 50, −100 to 0, 50 to 1000, etc., in response to the inspection target. The range is further narrowed and, for example, when a bone and a contrast vessel are to be discriminated from each other, if the range is limited to 200 to 500, it is effective.

For user input candidate creation concerning region extraction, any method may be adopted if it is a method of creating or selecting a region using a specification point. In this case, the specification point is one parameter and the range of the region created changes according to an additional parameter. Specific examples of user input candidate parameters are as follows: Initial placement and spring coefficient parameter of moving boundary in region extraction according to a GVF method (Gradient Vector Flow), a coefficient to exert a force attempting to eliminate the curvature on move interface in a Level Set method, and a combination of regions because a large number of finely partitioned regions are generated in region division according to a Water Shed method. An infinite number of combinations of the parameters are possible and therefore it is necessary to reduce the number of the parameters to a finite number according to the features of the result as with the algorithm in FIGS. 15 and 16. In image processing performing region extraction, a step of determining whether or not a clinically significant region can be acquired (additional processing at step S55) and a step of selecting only one region if a plurality of similar-shaped regions are obtained (additional processing at step S55) may exist and the parameter corresponding to the selected region can be adopted as a parameter candidate. In so doing, mutually similar parameters can be filtered and the number of parameters presented to the user can be reduced to a realistic number.

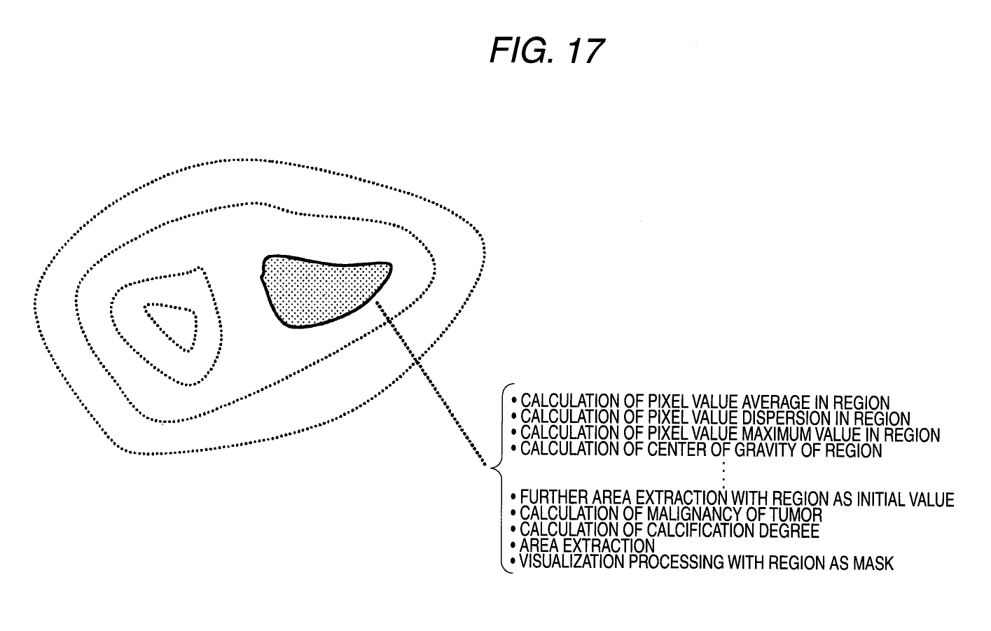

FIG. 17 is a schematic representation to show an example of additional image analysis processing. For the region extracted based on the user input prediction processing result, calculation of pixel value average in the region, calculation of pixel value dispersion in the region, calculation of pixel value maximum value in the region, calculation of center of gravity of the region, further region extraction with the region as an initial value, calculation of malignancy of tumor, calculation of calcification degree, region extraction, and visualization processing with the region as a mask may be performed.

In the description given above, the image processing server and the client are connected through the network by way of example, but the image processing server function and the client function may be contained in the same apparatus. The data server and the image processing server are connected through the network by way of example, but may be contained in the same apparatus. The processing is started when the medical image data arrives at the image processing server, but when the medical image data arrives at the data server, the data server may command the image processing server to perform processing. The image analysis processing may be performed using a plurality of algorithms in combination. Any other image processing such as filtering may be inserted before or after the image analysis processing described in the embodiment.

In the description given above, the system is implemented as a single image processing server by way of example, but may be made up of more than one image processing server. In this case, each of the image processing servers can conduct an image analysis on a different input candidate. Since image analysis can be conducted on different input candidates in parallel, the processing speed improves. A plurality of image processing servers can perform parallel processing if the image analysis can be conducted as parallel processing.

Thus, according to the image processing method of the embodiment, user input is predicted, a finite number of input candidates are created, and image analysis processing is performed using each of the input candidates, so that when the user selects an input candidate or specifies an input candidate by input, immediately the analysis result corresponding to the specified input candidate can be displayed.

In the embodiment, an image-analysis apparatus for causing a computer to execute the image processing method may be used.

Furthermore, according to one or more exemplary embodiments, previously the volume data is analyzed, a plurality of parameter candidates are created, and the image analysis processing is performed on the volume data based on each of the plurality of parameter candidates, whereby if any of the parameter candidates and the user-desired parameter match, the user can acquire the desired image analysis result in a short time. The volume data is analyzed for an infinite number of user input candidates, whereby the number of candidates can be reduced to a realistic number. In the invention, one parameter contains not only a parameter having one value, but also a parameter comprising a set of a plurality of values. For example, the threshold value and the specification point coordinates in region extraction according to a region expansion method, initial placement and spring coefficient parameter of move interface in region extraction according to a GVF method (Gradient Vector Flow), the coordinates of an artery for determining the observation field in perfusion image calculation and a rising frame, and the like are possible.

According to one or more exemplary embodiments, an infinite number of parameter candidates can be reduced to a fine number. Parameters with mutually similar results of the image analysis processing results based on the parameter candidates can be filtered and the number of parameters presented to the user can be reduced to a realistic number.

According to one or more exemplary embodiments, the image analysis processing is performed in the server having a high processing capability and the parameter or the image analysis processing result is selected through the user interface of the client, whereby the parameter or the image analysis processing result can be selected easily in a short time and any desired image analysis result can be immediately displayed for conducting image diagnosis smoothly.

According to one or more exemplary embodiments, if the parameter candidates do not contain any user-desired parameter, the user can manually specify any desired parameter, so that a precise image responsive to diagnosis can be displayed.

According to one or more exemplary embodiments, additional image analysis processing is performed on the result of the previously performed image analysis processing, so that image diagnosis containing the secondary use of a medical image can be conducted smoothly.

According to one or more exemplary embodiments, a plurality of image analysis processing results are displayed and the user can select any desired result from among the plurality of displayed image analysis processing results, so that the user need not think what parameters are. Accordingly, particularly if the number of parameters is enormous, the burden on the user is lightened and the user can be prevented from being psychologically induced to any parameter, resulting in careless operation.

According to one or more exemplary embodiments, the region extraction processing result is previously generated based on a plurality of parameters, whereby immediately the user can display the region of interest without being burdened by routine processing of deleting the bone region of a human being, etc., for example, in image diagnosis.

According to one or more exemplary embodiments, processing can be started at the timing at which the volume data arrives at the data server, so that it is made possible to shorten the wait time until the user acquires any desired image, and the user can conduct a smooth image diagnosis.

While the invention has been described in connection with the exemplary embodiments, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. An image processing method for performing image analysis processing on volume data based on a parameter, said image processing method comprising:
creating a plurality of parameter candidates by analyzing the volume data;
performing the image analysis processing on the volume data based on each of the plurality of parameter candidates; and
selecting at least one parameter from among the plurality of parameter candidates.

2. The image processing method as claimed in claim 1, wherein the plurality of parameter candidates are provided by filtering mutually similar results of the image analysis processing results based on the parameter candidates.

3. The image processing method as claimed in claim 1, wherein the image analysis processing is performed in a server and the parameter is selected through a user interface of a client.

4. The image processing method as claimed in claim 1, further comprising:
specifying any other parameter than the plurality of parameter candidates.

5. The image processing method as claimed in claim 1, further comprising:
performing additional image analysis processing on the image analysis processing result based on the selected parameter.

6. The image processing method as claimed in claim 1, wherein the image analysis processing is region extraction processing.

7. The image processing method as claimed in claim 1, wherein said step of creating a plurality of parameter candidates by analyzing volume data is triggered by the volume data arrival to a data server.

8. An image processing method for performing image analysis processing on volume data based on a parameter, said image processing method comprising:
creating a plurality of parameter candidates by analyzing the volume data;
performing the image analysis processing on the volume data based on each of the plurality of parameter candidates; and
selecting at least one result from among a plurality of image analysis processing results based on the plurality of parameter candidates.

9. The image processing method as claimed in claim 8, wherein the plurality of parameter candidates are provided by filtering mutually similar results of the image analysis processing results based on the parameter candidates.

10. The image processing method as claimed in claim 8, wherein the image analysis processing is performed in a server and the image analysis processing result is selected through a user interface of a client.

11. The image processing method as claimed in claim 8, further comprising:
specifying any other parameter than the plurality of parameter candidates.

12. The image processing method as claimed in claim 8, further comprising:
performing additional image analysis processing on the image analysis processing result based on the selected image analysis processing result.

13. The image processing method as claimed in claim 8, further comprising:
displaying the plurality of image analysis processing results.

14. The image processing method as claimed in claim 8, wherein the image analysis processing is region extraction processing.

15. The image processing method as claimed in claim 8, wherein said step of creating a plurality of parameter candidates by analyzing volume data is triggered by the volume data arrival to a data server.

16. An image-analysis apparatus performing an image analysis processing on volume data based on a parameter, said image analysis processing comprising:
creating a plurality of parameter candidates by analyzing the volume data;
performing the image analysis processing on the volume data based on each of the plurality of parameter candidates; and
selecting at least one parameter from among the plurality of parameter candidates.

17. The image-analysis apparatus as claimed in claim 16, wherein the plurality of parameter candidates are provided by filtering mutually similar results of the image analysis processing results based on the parameter candidates.

18. The image-analysis apparatus as claimed in claim 16, wherein the image analysis processing is performed in a server and the parameter is selected through a user interface of a client.

19. The image-analysis apparatus as claimed in claim 16, wherein said image analysis processing further comprises:
performing additional image analysis processing on the image analysis processing result based on the selected parameter.

20. An image-analysis apparatus performing an image analysis processing on volume data based on a parameter, said image analysis processing comprising:
creating a plurality of parameter candidates by analyzing the volume data;
performing the image analysis processing on the volume data based on each of the plurality of parameter candidates; and
selecting at least one result from among a plurality of image analysis processing results based on the plurality of parameter candidates.

21. The image-analysis apparatus as claimed in claim 20, wherein the plurality of parameter candidates are provided by filtering mutually similar results of the image analysis processing results based on the parameter candidates.

22. The image-analysis apparatus as claimed in claim 20, wherein the image analysis processing is performed in a server and the image analysis processing result is selected through a user interface of a client.

23. The image-analysis apparatus as claimed in claim 20, wherein said image analysis processing further comprises:
performing additional image analysis processing on the image analysis processing result based on the selected image analysis processing result.

24. The image-analysis apparatus as claimed in claim 20, wherein said image analysis processing further comprises:
displaying the plurality of image analysis processing results.
